(19) United States
(12) Patent Application Publication
(10) Pub. No.: US 2011/0206383 A1
(43) Pub. Date: Aug. 25, 2011

(54) SYSTEMS AND METHODS FOR PROVIDING AN OPTICAL INFORMATION TRANSMISSION SYSTEM

(75) Inventors: Hung-Chang CHIEN, Atlanta, GA (US); Arshad Chowdhury, Atlanta, GA (US); Gee-Kung Chang, Smyrna, GA (US)

(73) Assignee: GEORGIA TECH RESEARCH CORPORATION, Atlanta, GA (US)

(21) Appl. No.: 13/035,827

(22) Filed: Feb. 25, 2011

Related U.S. Application Data
(60) Provisional application No. 61/308,110, filed on Feb. 25, 2010.

(51) Int. Cl. H04B 10/04

(52) U.S. Cl. 398/187

(57) ABSTRACT

The present invention describes systems and methods of providing optical information transmission systems. An exemplary embodiment of the present invention includes a precoder configured to differentially encode a binary data signal, a duobinary encoder configured to encode the differentially encoded binary data signal as a three-level duobinary signal, an electrical-to-optical conversion unit configured to convert the three-level duobinary signal into a two-level optical signal, and an optical upconversion unit configured to modulate the two-level optical signal onto a higher frequency optical carrier signal and transmit the modulated higher frequency optical carrier signal onto an optical transmission medium.

### CROSS REFERENCE TO RELATED APPLICATION

This application claims the benefit of U.S. Provisional Patent Application No. 61/308,110, filed Feb. 25, 2010, the entire contents and substance of which are hereby incorporated by reference as if fully set forth below.

### FIELD OF THE INVENTION

The present invention relates generally to systems and methods for providing optical information transmission systems.

### BACKGROUND OF THE INVENTION

Computer processors have become ever present in our daily environment. Advances in microprocessor fabrication technology are enabling these processors to fit into smaller and smaller devices while providing more computing power. While the size of the devices is decreasing, the requirement for connectivity among these various devices is increasing. Today's applications are data-intensive, requiring frequent contact with online databases. The rising trend of cloud computing, where a significant portion of data processing is done in a distributed environment, requires these devices to be inter-connected in order to be effective. Meanwhile, the small size of the devices encourages mobility. Smartphones and tablet computers of today routinely boast more processing power then the large workstations of just a few years ago. Wireline connection of these smaller devices is often impractical, so many of them utilize wireless technologies to stay connected.

The advent of so many new online devices has led to a demand for larger network bandwidth. Millimeter-wave (MMW) communication, so named because signals in the range of 30 GHz to 300 GHz have a wavelength between one and ten millimeters, are growing in use due to their ability to accommodate more bandwidth than older technologies, such as microwave technology. However, computer technology development operates on a cycle where faster data speeds and increased bandwidth enable applications that require more data, which further compounds the original bandwidth problem. Various methods of delivering very high throughput data have arisen to increase the amount of data that can be sent over a given bandwidth. Recently, a 60 GHz single-carrier chip-to-chip transmission has demonstrated the delivery of data exceeding 7 Gbps quadrature phase-shift keying (QPSK) and 15 Gbps quadrature amplitude modulation (QAM) over 7 GHz unlicensed bandwidth. Technologies such as multi-carrier orthogonal frequency division multiplexing (OFDM) may enable even higher data rates. However, using communication technologies such as these requires high levels of power consumption on the transmitting and receiving ends. Furthermore, complex and expensive equipment is needed in the receiving devices which detect and demodulate these signals. The complexity and expense associated with high throughput data delivery in the MMW spectrum makes these solutions less than ideal when the market demands cheap and simple receiver devices with small form-factors.

Additional complications arise when MMW technology is used in wireless communication. With wireless technology, transmitters are configured to send data to wireless receivers. Depending on the frequency of the carrier signal, the transmitter and receiver can be separated by several meters or several kilometers. As the frequency of the carrier signal increases, the distance which the signal can travel decreases. In order to achieve high data throughput rates, most residential and business uses of wireless technology use carrier signals in the microwave range. Signals in this range are well-suited for use within buildings. The signals are powerful enough to permeate several floors and walls of a given building, but generally do not carry far enough to create widespread interference with users in other buildings.

However, because of their small wavelength, MMWs cannot penetrate solid objects such as walls or furniture. Additionally, the waves exhibit high levels of atmospheric loss, even over small distances with few obstructions. This limits their wireless use to situations where transmitters and receivers can be placed within a few meters of one another and within a line-of-sight. The many practical drawbacks of this technology means we may be approaching a limit to the amount of new bandwidth that can be utilized, particularly with wireless technology. Therefore, efficient means of making use of the available bandwidth are at a premium.

### BRIEF SUMMARY OF THE INVENTION

The present invention describes systems and methods of providing optical information transmission systems. An exemplary embodiment of the present invention includes a precoder configured to differentially encode a binary data signal, a duobinary encoder configured to encode the differentially encoded binary data signal as a three-level duobinary signal, an electrical-to-optical conversion unit configured to convert the three-level duobinary signal into a two-level optical signal, and an optical upconversion unit configured to modulate the two-level optical signal onto a higher frequency optical carrier signal and transmit the modulated higher frequency optical carrier signal onto an optical transmission medium.

In addition, the present invention provides methods of providing optical information transmission systems. An exemplary embodiment of a method of providing an optical information transmission system includes the step of differentially encoding a binary data signal, encoding the differentially encoded binary data signal into a three-level duobinary signal, converting the three-level duobinary signal into a two-level optical signal, modulating the two-level duobinary signal onto a higher frequency optical carrier signal and transmitting the modulated higher frequency optical carrier signal onto an optical transmission medium.

These and other objects, features and advantages of the present invention will become more apparent upon reading the following specification in conjunction with the accompanying drawing figures.

### BRIEF DESCRIPTION OF THE FIGURES

FIG. 1 provides an illustration of an optical information transmission system in accordance with an exemplary embodiment of the present invention.

FIG. 2 provides an illustration of another optical information transmission system in accordance with an exemplary embodiment of the present invention.

FIG. 3 is a block diagram of a method of providing an optical information transmission system in accordance with an exemplary embodiment of the present invention.

FIG. 4 provides eye diagrams for the data signal at various points in the transmission path of a device in accordance with the present invention.

FIG. 5 provides eye diagrams of the data signal before and after transmission through a fiber optic medium in an exemplary embodiment of the invention.

FIG. 6 provides an eye diagram of the data signal prior to wireless transmission in an exemplary embodiment of the invention.

### DETAILED DESCRIPTION

The present invention addresses the deficiencies in the prior art concerning the delivery of increased bandwidth using MMW technology without the subsequent increase in power consumption, cost, and hardware complexity. Significantly, the present invention provides methods and systems for providing an optical information transmission system. In an exemplary embodiment, an optical information transmission system provided in accordance with the present invention can enable a data rate of around twice the bandwidth of the pulse used to transmit the data. When further combined with wireless transmitters and receivers, it enables spectral-efficient wireless access without the need for decoders or complicated demodulators in the direct down-conversion receivers.

In an exemplary embodiment, the present invention provides an optical information transmission system including a precoder configured to differentially encode a binary data signal, a duobinary encoder configured to encode the differentially encoded binary data signal as a three-level duobinary signal, an electrical-to-optical (E/O) conversion unit configured to modulate the three-level duobinary signal into a two-level optical signal and an optical upconversion unit configured to modulate the two-level optical signal onto a higher frequency optical carrier signal and transmit the modulated higher frequency optical carrier signal onto an optical transmission medium. These components may serve as the headend in an optical information transmission system.

The present invention also provides methods for providing an optical information transmission system including differentially encoding a binary data signal, encoding the differentially encoded binary data signal into a three-level duobinary signal, converting the three-level duobinary signal into a two-level optical signal, modulating the two-level optical signal onto a higher frequency optical carrier signal and transmitting the modulated higher frequency optical carrier signal onto an optical transmission medium.

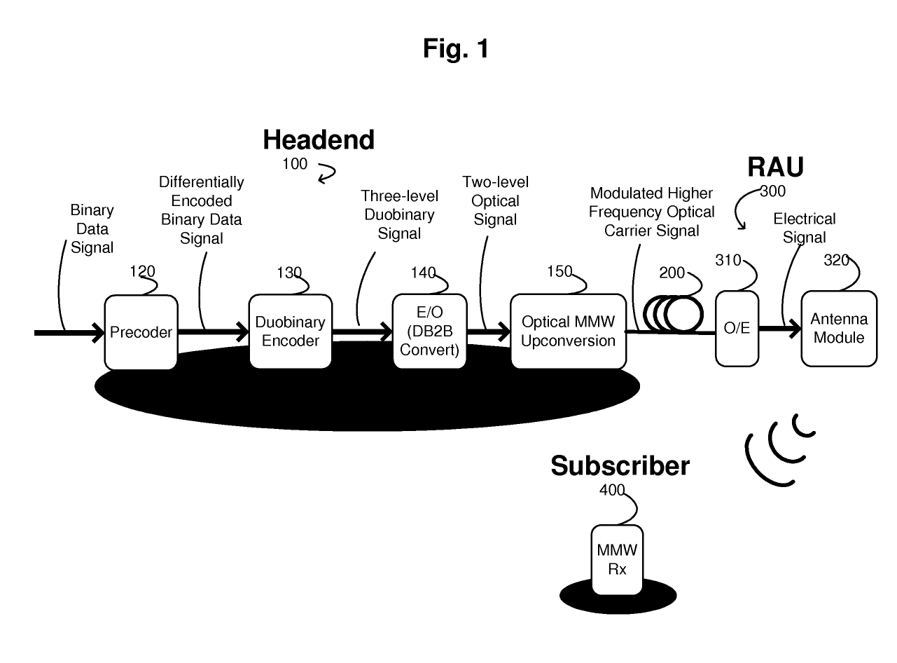

FIG. 1 provides an illustration of an optical information transmission system in accordance with an exemplary embodiment of the present invention. As shown in the exemplary embodiment of FIG. 1, the input to the optical information transmission system can include a signal carrying binary data. In an exemplary embodiment of the invention in accordance to FIG. 1, the signal carrying binary data can be received by a precoder 120. The precoder 120 in an exemplary embodiment can differentially encode the binary data signal prior to passing the signal to the duobinary encoder 130. Those of skill in the art will recognize that differentially encoding the signal in an exemplary embodiment can reduce the propagation of errors to an eventual receiver of the binary data signal due to inter-symbol interference during transmission of the signal. Next, in an exemplary embodiment, the precoder can generate a polarized signal centered around zero voltage by removing the DC offset gain of a differentially encoded binary data signal.

In an exemplary embodiment of the present invention, the duobinary encoder 130 can receive the differentially encoded binary data signal from the precoder 120. In an alternative exemplary embodiment, the duobinary encoder 130 can receive a non-differentially encoded signal carrying binary data. In an exemplary embodiment, the duobinary encoder 130 can create a three-level output signal in the electric field from the received signal. In an exemplary embodiment of the invention, the duobinary encoder 130 can use a low pass filter (LPF) to achieve the three-level output. Those of skill in the art will understand that various other methods of creating a three-level output can be utilized.

In an exemplary embodiment of the invention, the duobinary encoder 130 can pass the three-level output signal to an electrical-to-optical (E/O) conversion unit 140. In an exemplary embodiment of the invention, the E/O conversion unit 140 can convert the three-level duobinary signal into a two-level signal and convert the signal from the electrical field to the optical field. In an exemplary embodiment of the invention, these conversions can be accomplished simultaneously within the E/O conversion unit 140 by using the three-level output signal of the duobinary encoder 130 to drive an optical intensity modulator (IM) which in turn modulates a laser diode (LD).

In an exemplary embodiment of the invention, an optical upconversion unit 150 can then modulate the two-level optical signal onto a higher-frequency optical carrier signal. In an exemplary embodiment, the optical carrier signal can have a frequency within the MMW range of 30 GHz to 300 GHz. After modulation onto a higher frequency carrier signal, an optical upconversion unit 150 in accordance with an exemplary embodiment of the present invention can suppress the central carrier signal using an optical filter. In an exemplary embodiment, the optical upconversion unit 150 can place the modulated higher-frequency optical carrier signal onto an optical transmission medium 200.

As described in I. P. Kamino et al., Optical Fiber Telecommunications V., 2008, which is hereby incorporated by reference in its entirety as if fully set forth herein, when a binary data signal is differentially encoded, duobinary encoded, then converted into a two-level optical signal, the two-level optical signal theoretically represents the original binary data signal while using only 50% of the bandwidth used by the original binary data signal. By upconverting the signal onto a MMW carrier signal, the present invention directly leverages this process, traditionally used only in wireline communications, as a spectrum-compressing means for optical-wireless systems such as radio-over-fiber (RoF), in-building distributed antenna systems, and other such combinations.

In an optical-wireless network, such as RoF, optical fiber is used to carry data across long distances spanning up to several kilometers. The data is then transferred onto wireless networks for delivery across much smaller distances to the endpoint receivers. When RoF systems utilize MMW technology, the physical arrangement of the devices resembles that of a traditional wireline network more than a traditional wireless network. In wireline systems, each device is physically plugged into the network via a cable that connects to a router, a port, or to another device. The distance between any one device and network it plugs into is limited by the length of the cable connecting the two, usually only a few meters. In contrast, for RoF systems operating in the microwave range, the endpoint receivers can be physically located further from the wireless transmitters, often in separate rooms, or in some cases, separate floors. When RoF systems utilize MMW technology, the limited reach of the wireless signal encourages the arrangement of the receivers so that they are in close proximity to the transmitters and, in some embodiments, within a line of sight. By using the wireline technique of duobinary encoding in accordance to an exemplary embodiment of the present invention to aid in transmitting information wirelessly, the bit rate over a given channel bandwidth can be approximately doubled without any hardware change (such as demodulators) in the wireless receiver.

In an exemplary embodiment, an optical-to-electrical (O/E) converter 310 can convert the modulated higher frequency optical carrier signal into an electrical signal. In an exemplary embodiment of the invention, an antenna module 320 comprising a wireless antenna can then receive the electrical signal from the O/E converter 310 and transmit a radio frequency (RF) carrier signal onto which the electrical signal is modulated. In exemplary embodiments which feature an antenna module 320 connected to an O/E converter unit 310, the two components form a remote access unit 300.

In an exemplary embodiment, a subscriber unit 400 including a wireless antenna can be configured to receive an RF carrier signal onto which an electrical signal is modulated from an antenna module 320 of a remote access unit 300. The subscriber unit 400 in an exemplary embodiment can then decode the electrical signal into the binary data signal. In one embodiment, the electrical signal can be decoded by mixing it with a sine wave having the same frequency as the original carrier wave and passing the output through an LPF configured to pass frequencies in the range of the binary data signal's data rate. In an alternative embodiment, the electrical signal can be passed through an envelope detector to decode the signal.

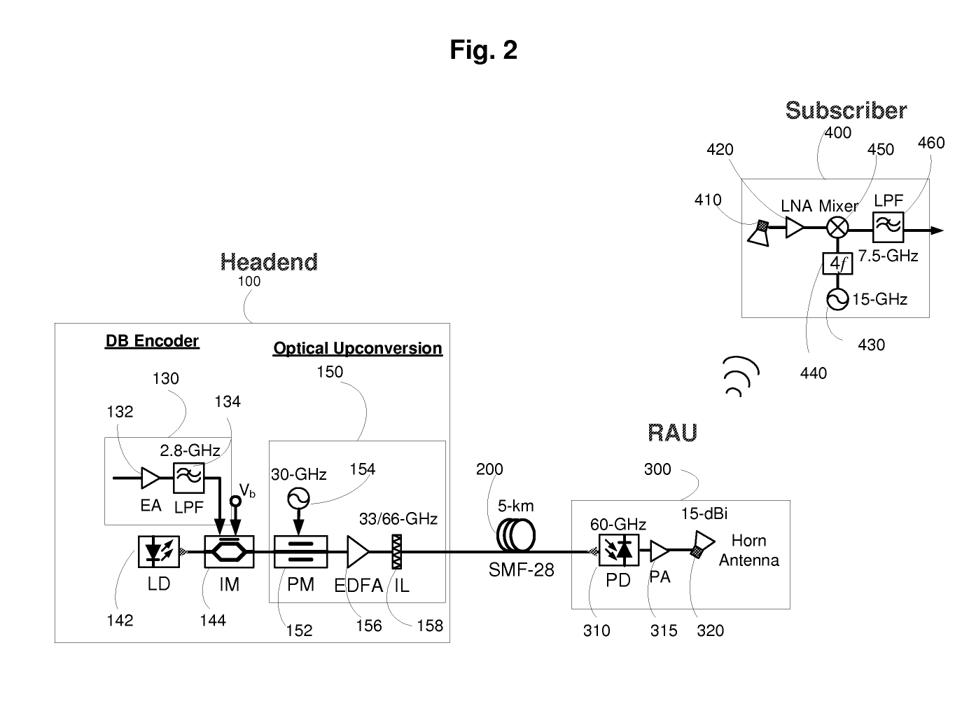

FIG. 2 illustrates an optical information transmission system in accordance with an exemplary embodiment of the invention. In an exemplary embodiment, the duobinary encoder 130 can receive a differentially encoded binary data signal from the precoder 120. In an alternative embodiment, the duobinary encoder can receive a binary data signal which has not been differentially encoded by the precoder 120. In the illustration of an exemplary embodiment shown in FIG. 2, the binary data signal has a data rate of 10 Gbps. Those of skill in the art will understand the binary data signal may have a data rate which is higher or lower than the rate selected in this example. The binary data signal in this exemplary embodiment can be passed through an electrical amplifier (EA) 132 and into a Bessel electrical LPF 134 with a 3 dB-bandwidth of 2.8 GHz, which is about 25% of the bit rate. In an exemplary embodiment, the three-level duobinary signal, which can have a bias voltage of 3.2V at its transmission null, can be used to drive an LiNbO₃ IM 144. In an exemplary embodiment, the IM 144 can modulate an LD 142 at 1553.2 nm to simultaneously convert the duobinary signal into a two-level data signal and convert the duobinary signal from an electrical field to an optical field. In an exemplary embodiment, the EA 132 with saturation output power of 7.8V boosts the driving electrical duobinary signal and ensures that the IM 144 can be driven at full swing (2Vπ) to maximize the extinction ratio of the converted two-level optical signal.

In an exemplary embodiment of the upconversion unit illustrated in FIG. 2, the two-level optical signal can be modulated using double side-band suppressed-carrier modulation. In the exemplary embodiment in accordance to the present invention, the two-level optical signal can feed into an optical phase modulator (PM) 152 driven by a 30 GHz sinusoidal wave for all-optical upconversion. In an exemplary embodiment, the central carrier signal can be filtered by using a 33/66 GHz optical interleaver 158 to double the beating frequency of the generated optical MMW. In the exemplary embodiment shown in FIG. 2, the modulated higher frequency optical carrier signal can be comprised of a 60 GHz optical MMW carrying a 10 Gbps binary signal. In an exemplary embodiment, the modulated higher frequency optical carrier signal can be transmitted across a 5 km single-mode fiber 200. Those skilled in the art will recognize that various other optical carriers can be used for the transmission.

The exemplary embodiment illustrated in FIG. 2 shows a remote access unit (RAU) 300 which can convert the modulated higher frequency optical carrier signal into an electrical signal and transmit an RF carrier signal onto which the electrical signal is modulated. In that preferred embodiment, a 60 GHz optical MMW carrying a 10 Gbps binary signal can be directly detected by a 60 GHz photodiode (PD) 310 and converted to a 60 GHz electrical signal. In an exemplary embodiment, the 60 GHz electrical signal can be further boosted by a power amplifier (PA) 315 and radiated to free space through a 60 GHz horn antenna module 320 with a 15 dBi gain and 22 degree E/H plane 3 dB beam width.

In an exemplary embodiment of the subscriber 400 illustrated in FIG. 2, a 60 GHz antenna 410 can receive a 60 GHz electrical signal from the antenna module 320 in the RAU 300 and pass the 60 GHz electrical signal through a low noise amplifier (LNA) 420. In an exemplary embodiment, the LNA 420 can boost the portion of the 60 GHz electrical signal carrying the data. In the exemplary embodiment shown in FIG. 2, a 15 GHz synthesizer 430 and a 1×4 multiplier (4f) 440 are combined to supply a 60 GHz local oscillator which drives a V-band mixer 450. In the embodiment shown in FIG. 2, the resulting signal has a 60 GHz baseband with some higher order harmonics. In an exemplary embodiment, the signal can be passed through a 7.5 GHz LPF 460 which filters out the baseband and the higher order harmonics, leaving the binary data signal. In the embodiment illustrated in FIG. 2, an LPF 460 of 7.5 GHz can be used to recover the 10 Gbps data signal, because the bandwidth of the data in this embodiment is approximately 5 GHz wide, even though the data rate is approximately 10 Gbps. As this embodiment illustrates, an advantage of the present invention is that less expensive equipment can be used to retrieve the signal because the bandwidth is only 50% as wide as would be necessary without the present invention. In another exemplary embodiment, an envelope detector can replace the mixer 450 and LPF 460 and perform the same function with even less expense and fewer components.

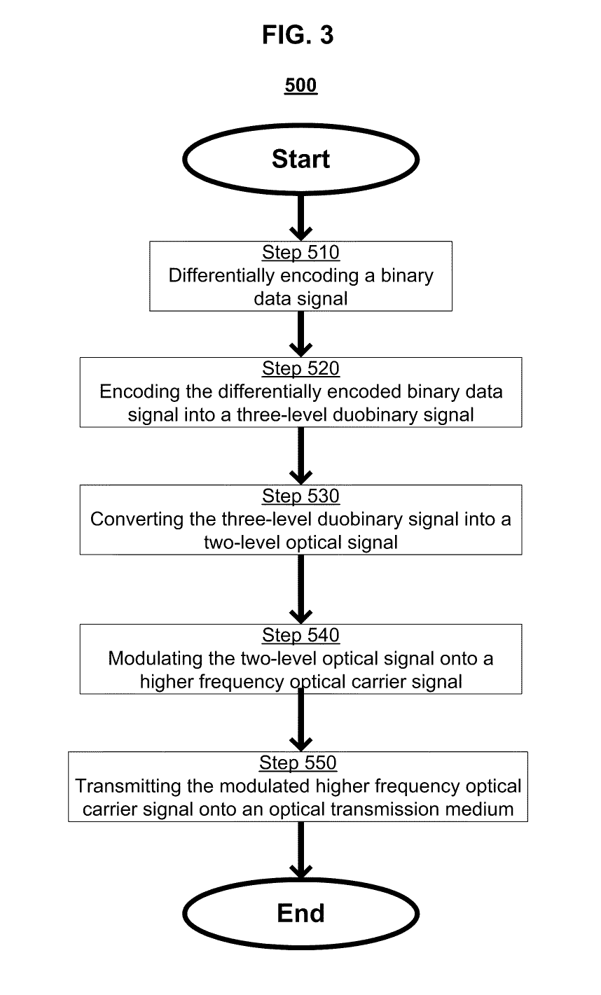

FIG. 3 provides a block diagram illustration of a method for providing an optical information transmission system 500 in accordance with an exemplary embodiment of the present invention. As shown in FIG. 3, the first step 510 in an exemplary embodiment of the method for providing an optical information transmission system can involve differentially encoding a binary data signal. When a binary data signal is differentially encoded in a preferred embodiment, the risk of propagating errors throughout the transmission is reduced. In some exemplary embodiments of the method, this differential encoding step 510 can be implemented by a software algorithm. For example and not limitation, the present bit of the binary data signal can be joined with the previous bit using an XOR operation. Those of skill in the art will understand that other methods for differentially encoding the data can be used. In alternative embodiments of the method, the differential encoding step 510 can be performed physically in hardware.

The second step 520 involves encoding the differentially encoded binary data signal into a three-level duobinary signal. In an alternative exemplary embodiment of the present invention, a non-differentially encoded binary data signal can be encoded into a three-level duobinary signal. In an exemplary embodiment, a delayed feedback can be used to add the present bit of the data signal to the previous bit to accomplish step 520. In an alternative embodiment, an LPF can be used to achieve step 520. Those of skill in the art will understand that other methods of duobinary encoding the data signal are available. When binary data is duobinary encoded according to an exemplary embodiment of the method for providing an optical information transmission system 500 the bandwidth needed to represent the binary data signal can be reduced by about 50%. In an exemplary embodiment of the invention, a duobinary encoder can perform this step.

In an exemplary embodiment of the invention, the three-level duobinary signal can be converted into a two-level optical signal as shown in step 530. This step includes converting the signal from the electrical field to the optical field. It also includes converting the representation of data from a three-level representation to a binary representation. In an exemplary embodiment of the invention, this step can be performed by an electrical-to-optical converter. In step 540, the two-level optical signal can be modulated onto a higher frequency optical carrier signal. Those of skill in the art will understand that various methods of modulation can be utilized for this step. For example and not limitation, double-sideband, single-sideband, double-sideband with suppressed carrier and other forms of modulation can be used in exemplary embodiments. In an exemplary embodiment, the higher frequency optical carrier signal can have a frequency in the MMW range. In an exemplary embodiment of the invention, the modulated higher frequency optical carrier signal can be transmitted onto an optical transmission medium 550. In an exemplary embodiment of the invention, either or both of steps 540 and 550 can be implemented by an optical upconverter unit.

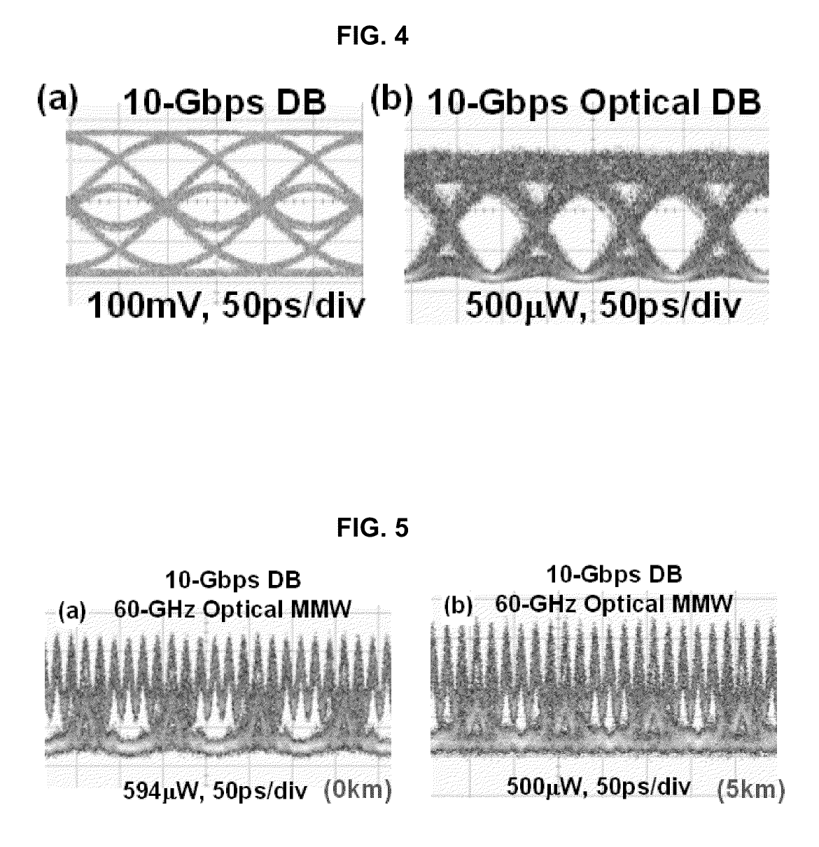

FIG. 4 provides eye diagrams of a data signal at various points during the transmission path in the headend 100 of an exemplary embodiment of the invention. FIG. 4 chart (a) illustrates the eye diagram of a 10 Gbps, three-level electrical signal output from a duobinary encoder 130 in accordance with the present invention and configured as depicted in FIG. 2. FIG. 4 chart (b) illustrates the eye diagram of a 10 Gbps, two-level optical signal output from an E/O converter in accordance with the present invention and configured as depicted in FIG. 2.

FIG. 5 provides eye diagrams of a two-level optical signal before and after transmission through a fiber optic medium 200 of an exemplary embodiment of the invention. FIG. 5(a) illustrates the eye diagram of a 60 GHz optical MMW carrying a 10 Gbps two-level data signal at a point prior to transmission across an optical transmission medium 200 in accordance with an exemplary embodiment of the present invention configured as depicted in FIG. 2. FIG. 5(b) illustrates the eye diagram of a 60 GHz optical MMW carrying a 10 Gbps two-level data signal at a point after transmission across a 5 km single mode fiber 200 in accordance with an exemplary embodiment of the present invention configured as depicted in FIG. 2.

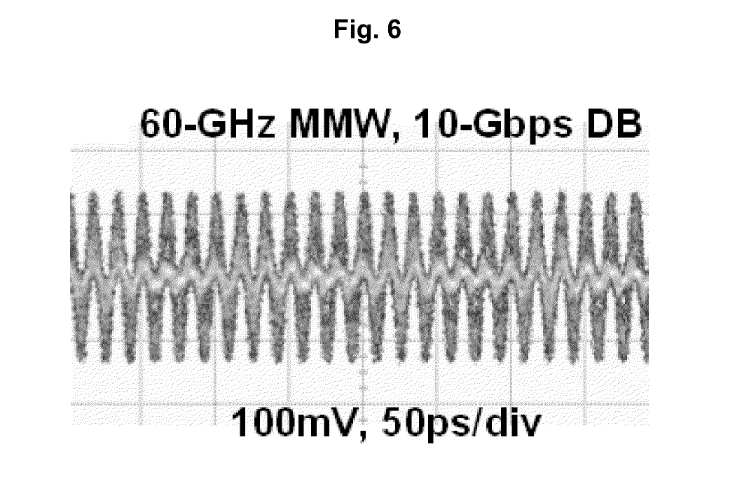

FIG. 6 provides an eye diagram of a modulated higher frequency electrical carrier signal prior to wireless transmission in an exemplary embodiment of the invention. The signal in FIG. 6 is an example of a 60 GHz electrical MMW output from a PA 315 just prior to wireless transmission through a horn antenna module 320 in accordance with an exemplary embodiment of the present invention configured as depicted in FIG. 2.

What is claimed is:

1. An optical information transmission system comprising:
a duobinary encoder configured to encode a binary data signal as a three-level duobinary signal;
an electrical-to-optical conversion unit configured to convert the three-level duobinary signal into a two-level optical signal; and
an optical upconversion unit configured to modulate the two-level optical signal onto a higher frequency optical carrier signal and transmit the modulated higher frequency optical carrier signal onto an optical transmission medium.

2. The optical information transmission system of claim 1, further comprising a precoder configured to differentially encode a binary data signal.

3. The optical information transmission system of claim 1, further comprising an optical-to-electrical conversion unit coupled to the optical transmission medium and configured to receive the modulated higher frequency optical signal and convert the modulated higher frequency optical carrier signal into an electrical signal.

4. The optical information transmission system of claim 3, further comprising a first wireless antenna operatively connected to the optical-to-electrical conversion unit and configured to transmit an RF carrier signal onto which the electrical signal is modulated.

5. The optical information transmission system of claim 4, further comprising a subscriber comprising a second wireless antenna configured to receive the RF carrier signal onto which the electrical signal is modulated from the first wireless antenna wherein the subscriber is also configured to decode the electrical signal into the binary data signal.

6. The optical information transmission system of claim 3, wherein the electrical signal has a frequency higher than approximately 30 GHz.

7. The optical information transmission system of claim 1, wherein the higher frequency optical carrier signal has a frequency higher than approximately 30 GHz.

8. The optical information transmission system of claim 1, wherein the optical upconversion unit modulates the two-level optical signal onto the higher frequency optical carrier signal using double side-band modulation with central carrier suppression.

9. A method for providing an optical information transmission system comprising:
encoding a binary data signal into a three-level duobinary signal;
converting the three-level duobinary signal into a two-level optical signal;
modulating the two-level optical signal onto a higher frequency optical carrier signal; and
transmitting the modulated higher frequency optical carrier signal onto an optical transmission medium.

10. The method for providing an optical information transmission system of claim 9, further comprising differentially encoding a binary data signal.

11. The method for providing an optical information transmission system of claim 9, further comprising receiving the modulated higher frequency optical carrier signal from the optical transmission medium and converting the modulated higher frequency optical carrier signal into an electrical signal.

12. The method for providing an optical information transmission system of claim 11, further comprising transmitting an RF carrier signal onto which the electrical signal is modulated from a first wireless antenna.

13. The method for providing an optical information transmission system of claim 12, further comprising receiving the RF carrier signal onto which the electrical signal is modulated from a second wireless antenna in communication with the first wireless antenna.

14. The method for providing an optical information transmission system of claim 13, further comprising decoding the electrical signal into the binary data signal.

15. The method for providing an optical information transmission system of claim 11, wherein the electrical signal has a frequency higher than approximately 30 GHz.

16. The method for providing an optical information transmission system of claim 9, wherein the optical carrier signal has a frequency higher than approximately 30 GHz.

17. The method for providing an optical information transmission system of claim 9, wherein modulating the two-level optical signal onto a higher frequency optical carrier signal comprises using double side-band modulation with central carrier suppression.
